(19) United States
(12) Patent Application Publication
(10) Pub. No.: US 2023/0406046 A1
(43) Pub. Date: Dec. 21, 2023

(54) TIRE INFORMATION DETECTION DEVICE

(71) Applicants: The Yokohama Rubber Co., LTD., Tokyo (JP); ALPS ALPINE CO., LTD., Tokyo (JP)

(72) Inventors: Masahiro NARUSE, Kanagawa (JP); Jun MATSUDA, Kanagawa (JP); Heishiro FUDO, Tokyo (JP); Eiji SHINOHARA, Tokyo (JP); Shinya ICHISE, Tokyo (JP); Shinichi SEO, Tokyo (JP); Yuki OHNO, (US)

(21) Appl. No.: 18/247,694

(22) PCT Filed: Sep. 21, 2021
(86) PCT No.: PCT/JP2021/034525

§ 371 Date: Apr. 3, 2023

(30) Foreign Application Priority Data
Oct. 8, 2020 (JP) 2020-170401

(51) Int. Cl. B60C 11/24; B60C 19/00

(52) U.S. Cl. CPC B60C 11/246; B60C 19/00; B60C 2019/004

(57) ABSTRACT

A tire information detection device that detects tire information including at least one of wear, deformation, road surface state, ground contact state, presence/absence of failure, travel history, load state, or frictional coefficient, includes at least one detection unit disposed on a tire inner surface, a power supply unit to supply power to the detection unit, a position information detection unit to detect position information of the tire or a vehicle, an additional information acquisition unit to acquire additional information associated with the position information, a determination unit to determine whether a current position specified based on the position information is included in an area that satisfies a determination condition extracted from the additional information, and a control unit to control measurement of the detection unit based on a determination result from the determination unit.

### TECHNICAL FIELD

The present technology relates to a tire information detection device, and more particularly, to a tire information detection device that enables tire information to be detected in the right place at the right time while reducing a measurement frequency of a detection unit (sensor) installed in a tire as much as possible to extend the service life of a power supply unit.

### BACKGROUND ART

Tire information (a state of wear of a tread portion) of a pneumatic tire has been evaluated based on a measurement value of an acceleration measured by, for example, an acceleration sensor installed in the tire (see, for example, Japan Unexamined Patent Publication No. 2009-18667 A). Such a sensor typically uses a battery as a power supply and has a function of transmitting measurement data measured by the sensor to the outside. As the number of measurements and transmissions made by such a sensor increases, the battery is more consumed, resulting in shorter battery life. Although the battery life can be improved by reducing the measurement frequency of the sensor to the minimum required, in that case, equipping the sensor with a trigger function to encourage the sensor to measure is necessary.

### SUMMARY

The present technology provides a tire information detection device that enables tire information to be detected in the right place at the right time while reducing a measurement frequency of a detection unit (sensor) installed in a tire as much as possible to extend the service life of a power supply unit.

A tire information detection device according to an embodiment of the present technology is configured to detect tire information including at least one of wear of a tire, deformation of the tire, a road surface state, a ground contact state of the tire, presence or absence of failure of the tire, a travel history of the tire, a load state of the tire, or a frictional coefficient. The tire information detection device includes at least one detection unit disposed on a tire inner surface, a power supply unit configured to supply power to the detection unit, a position information detection unit configured to detect position information of the tire or a vehicle, an additional information acquisition unit configured to acquire additional information associated with the position information, a determination unit configured to determine whether a current position specified based on the position information is included in an area that satisfies a determination condition extracted from the additional information, and a control unit configured to control measurement of the detection unit based on a determination result from the determination unit.

An embodiment of the present technology includes the at least one detection unit disposed on the tire inner surface, the power supply unit configured to supply power to the detection unit, the position information detection unit configured to detect position information of the tire or a vehicle, the additional information acquisition unit configured to acquire additional information associated with the position information, the determination unit configured to determine whether a current position specified based on the position information is included in an area that satisfies the determination condition extracted from the additional information, and the control unit configured to control the measurement of the detection unit based on a determination result from the determination unit. Thus, the detection unit is configured to perform measurement by using the position information of the tire or the vehicle when the current position specified based on the position information is included in the area that satisfies the determination condition extracted from the additional information. That is, the tire information detection device according to an embodiment of the present technology includes a trigger function to encourage the detection unit to measure. Thus, measurement can be performed in the right place at the right time instead of constant measurement, and the measurement frequency of the detection unit can be reduced as much as possible to reduce power consumption. This can detect tire information in the right place at the right time while extending the service life of the power supply unit.

In the tire information detection device according to an embodiment of the present technology, preferably, the determination unit has at least two determination conditions and selectively uses the at least two determination conditions according to tire information as a detection target. This can provide extension of the service life of the power supply unit and detection of the tire information in the right place at the right time in a compatible manner.

Preferably, the tire information detection device further includes an accident occurrence risk calculation unit configured to calculate an index value of an accident occurrence risk in each area based on the number of accident occurrences included in the additional information, the determination unit uses the index value of the accident occurrence risk in each area as the determination condition, and the control unit controls the measurement of the detection unit based on the index value of the accident occurrence risk in an area including the current position. This leads to reduction of the accident occurrence risk while extending the service life of the power supply unit and thus can improve the safety.

Preferably, the tire information includes wear of a tire, the determination unit uses information related to the wear of the tire included in the additional information as the determination condition, and the measurement made by the detection unit is repeated until a tire rotation speed reaches 10 rotations or more. This can improve, particularly in detecting the wear of the tire as the tire information, the determination accuracy of the progress of the wear of the tire while extending the service life of the power supply unit.

Preferably, the tire information detection device further includes a measurement frequency calculation unit configured to calculate an index value of a measurement frequency of the detection unit based on environmental information included in the additional information, the determination unit uses the index value of the measurement frequency of the detection unit as the determination condition, and the control unit controls the measurement of the detection unit based on the index value of the measurement frequency of the detection unit in an area including the current position. This leads to reduction of the accident occurrence risk while extending the service life of the power supply unit and thus can improve the safety.

Preferably, the tire information detection device further includes an image comparison calculation unit configured to compare a prerecorded surrounding image of the vehicle included in the additional information with an image during travel to calculate a concordance rate of images, the determination unit uses the concordance rate of the images as the determination condition, and the control unit controls the measurement of the detection unit based on the concordance rate of the images in an area including the current position. This leads to reduction of the accident occurrence risk and thus can improve the safety.

Preferably, the tire information detection device further includes a measurement history recording unit configured to record a measurement history of the detection unit at the current position specified based on the position information, the determination unit uses presence or absence of the measurement history of the detection unit as the determination condition, and the control unit controls the measurement of the detection unit based on the presence or absence of the measurement history of the detection unit in an area including the current position. This leads to reduction of the accident occurrence risk and thus can improve the safety.

Preferably, the tire information detection device further includes a danger avoidance behavior recording unit configured to record information about danger avoidance behavior at the current position specified based on the position information; and a danger index calculation unit configured to calculate an index value of danger in each area based on the information about the danger avoidance behavior, the determination unit uses the index value of the danger in each area as the determination condition, and the control unit controls the measurement of the detection unit based on the index value of the danger in an area including the current position. This leads to reduction of the accident occurrence risk and thus can improve the safety.

### BRIEF DESCRIPTION OF DRAWINGS

FIG. 1 is an explanatory diagram illustrating an example of a tire information detection device according to an embodiment of the present technology.

FIG. 2 is a flowchart illustrating an example of a procedure of a detection method using a tire information detection device according to an embodiment of the present technology.

FIG. 3 is a flowchart illustrating a modified example of a procedure of a detection method using a tire information detection device according to an embodiment of the present technology.

FIG. 4 is a meridian cross-sectional view illustrating a pneumatic tire whose tire information is detected by a tire information detection device according to an embodiment of the present technology.

### DETAILED DESCRIPTION

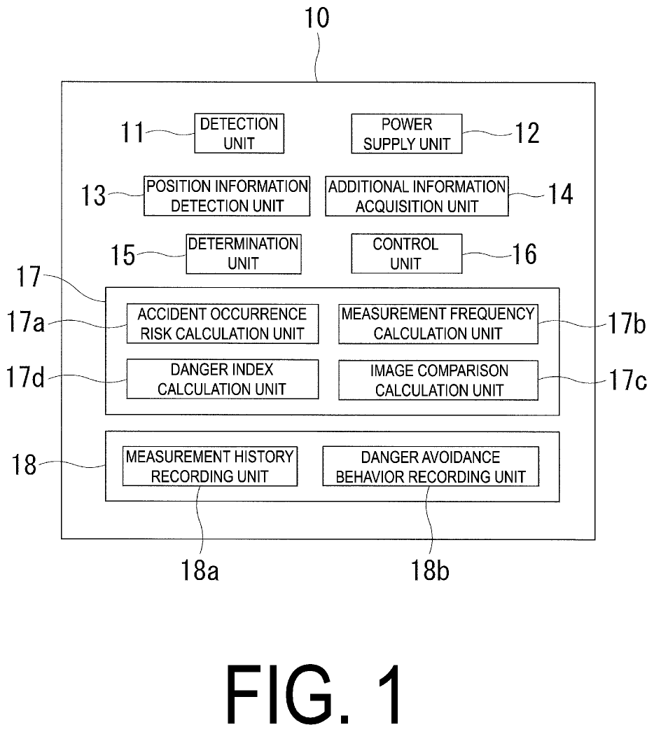

Configurations of embodiments of the present technology will be described in detail below with reference to the accompanying drawings. FIG. 1 illustrates a tire information detection device according to an embodiment of the present technology.

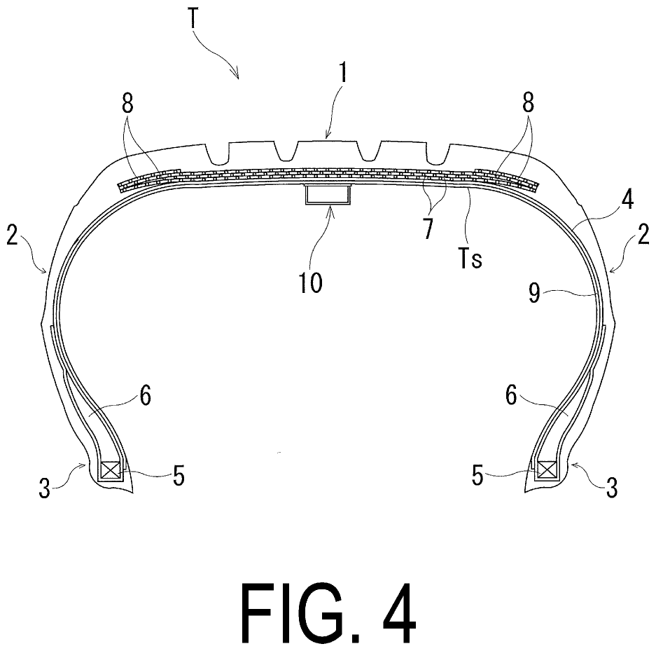

In detecting tire information of a tire T (see, for example, FIG. 4), a tire information detection device 10 detects the tire information of the tire T while controlling the measurement of the detection unit 11 described later based on the position information of the tire T or a vehicle on which the tire T is mounted.

The tire information is a group consisting of wear of a tire, deformation of the tire, a road surface state, a ground contact state of the tire, presence or absence of failure of the tire, a travel history of the tire, a load state of the tire, and a frictional coefficient. At least one of this group can b e selected and utilized as tire information. The tire information is not limited to the above-described group and may be added as appropriate.

As illustrated in FIG. 1, the tire information detection device 10 includes at least one detection unit 11 configured to detect the state of a tire, a power supply unit 12 configured to supply power to the detection unit 11, a position information detection unit 13 configured to detect position information of the tire or the vehicle, an additional information acquisition unit 14 configured to acquire additional information associated with the position information, a determination unit 15 configured to determine whether a current position of the tire or the vehicle is included in an area that satisfies a specific determination condition, and a control unit 16 configured to control measurement of the detection unit 11 based on the determination result from the determination unit 15. The processing performed by each of the position information detection unit 13, the additional information acquisition unit 14, the determination unit and the control unit 16 may be performed on the vehicle side or on the cloud side communicably connected.

The tire information detection device 10 can further include a calculation unit 17 configured to perform various types of computational processing and a recording unit 18 configured to record various types of data. Further, devices such as an input device, an output device, and a display may be appropriately added to the tire information detection device 10.

The detection unit 11, which is not limited to a particular detection unit, may appropriately include, for example, a voltage detection unit (potential sensor) that detects a potential difference in an element that generates a voltage in response to deformation of the tread portion during tire rotation, a speed detection unit (speed sensor) that detects the vehicle speed or the rotational speed of the tire, an air pressure detection unit (pressure sensor) that detects the internal pressure of the tire, and a temperature detection unit (temperature sensor) that detects the internal temperature of the tire. The detection unit 11 also includes a transmitter that transmits data to the outside. Data detected by the detection unit 11 is recorded in the recording unit 18.

A battery, for example, can be used as the power supply unit 12, but no such limitation is intended. It is only required that the power can be supplied to the detection unit 11 and that the power is supplied in a non-contact manner such as using radio waves. The power supply unit 12 can supply power not only to the detection unit 11 but also to the position information detection unit 13, the additional information acquisition unit 14, the determination unit 15, the control unit 16, the calculation unit 17, and the recording unit 18.

The position information detection unit 13 can continuously detect the position information of the tire or the vehicle and specify the current position of the tire or the vehicle based on the position information. This position information is information including the latitude, longitude, and altitude of the point where the tire or the vehicle is located. When a compact global positioning system (GPS), for example, is used as the position information detection unit 13, the position information detection unit 13 can be mounted on the tire information detection device 10. The position information detection unit 13 may acquire position information from a GPS mounted on the vehicle, and in that case, the position information detection unit 13 is provided with a communication means (transmitter and receiver) with the GPS of the vehicle. The GPS detects position information (latitude, longitude, and altitude) of the tire or the vehicle by receiving radio waves from satellites.

The additional information acquisition unit 14 acquires additional information associated with the position information of the tire or the vehicle. This additional information may appropriately include surrounding buildings, road curvature, road gradients, road signs, intersections, up and down tracks, median strips, accident-prone areas, congestion-prone areas, flooded areas, snow-covered areas, areas where fallen leaves tend to accumulate, weather information, hours of sunshine, images from a camera or a drive recorder mounted on the vehicle, and satellite images of the surroundings of the vehicle, that correspond to the position information of the tire or the vehicle. When an internal recording device such as a RAM (random access memory) is used as the additional information acquisition unit 14, the additional information acquisition unit 14 can be mounted in the tire information detection device 10. The additional information acquisition unit 14 may use information recorded in a navigation system mounted on the vehicle, and in that case, the additional information acquisition unit 14 is provided with a communication means (transmitter and receiver) with the navigation system of the vehicle. In particular, the additional information acquisition unit 14 is preferably configured to communicate with an external database, and in that case, the additional information can be updated as needed, allowing the latest additional information to be acquired.

The additional information acquisition unit 14 extracts, according to the tire information as the detection target, specific information from the additional information associated with the position information. The extracted additional information is recorded in the additional information acquisition unit 14 itself and used as the determination condition of the determination unit 15. For example, when the detection target is a road surface state, road signs, intersections, accident-prone areas, congestion-prone areas, flooded areas, snow-covered areas, areas where fallen leaves tend to accumulate, weather information, hours of sunshine, images from a camera or a drive recorder mounted on the vehicle, satellite images of the surroundings of the vehicle, and the like are extracted as appropriate from among the additional information. When the detection target is wear of a tire, surrounding buildings, accident-prone areas, areas where a user is highly likely to travel on a steady state (areas where the user travel on a specific road at a similar speed), and the like are extracted as appropriate from among the additional information. When the detection target is deformation of the tire or a load state of the tire, surrounding buildings, accident-prone areas, and the like are extracted as appropriate from among the additional information.

The determination unit 15 determines whether the current position specified based on the position information of the tire or the vehicle is included in an area that satisfies the determination condition. In this case, the determination unit 15 makes the determination by using the determination condition extracted by the additional information acquisition unit 14 according to the tire information as the detection target. The determination unit 15 appropriately reads the determination condition from the additional information acquisition unit 14 or the recording unit 18 and executes determination. In addition, the “area that satisfies the determination condition” means an area (range) that includes both a case where the current position is a point that exactly satisfies the determination condition and a case where the current position is close to the point that satisfies the determination condition.

It is preferable that the determination unit 15 has at least two determination conditions and selectively uses the at least two determination conditions according to the tire information as the detection target. This is because an appropriate determination condition may differ depending on the tire information as the detection target.

The control unit 16 controls measurement of the detection unit 11 based on the determination result from the determination unit 15. Specifically, when the current position of the tire or the vehicle is included in an area that satisfies a determination condition, the control unit 16 controls the detection unit 11 to start measurement or continue measurement if the measurement is already in progress. On the other hand, when the current position of the tire or the vehicle is not included in the area that satisfies the determination condition, the control unit 16 controls the detection unit 11 not to start measurement or to end measurement if the measurement is already in progress.

The calculation unit 17 can be composed of, for example, a memory or a CPU (central processing unit). The calculation unit 17 can store a calculated index value in the recording unit 18 and read the stored index value to perform calculation. The calculation unit 17 can also correct the determination condition extracted from the additional information associated with the position information. For example, when the detection target is deformation of the tire or a load state of the tire, the calculation unit 17 corrects the determination condition based on the road gradient and vehicle information (information such as axle load, the number of passengers, brake pressure, and steering angle). The calculation unit 17 can include an accident occurrence risk calculation unit 17a, a measurement frequency calculation unit 17b, an image comparison calculation unit 17c, and a danger index calculation unit 17d.

The accident occurrence risk calculation unit 17a calculates an index value of an accident occurrence risk in each area based on the information about the accident-prone areas (for example, information about the number of accident occurrences in each area) included in the additional information acquired by the additional information acquisition unit 14. Specifically, the ratio of the number of accident occurrences in a specific area to the total number of accidents in any range (for example, city or prefecture) is calculated to quantify the accident occurrence risk in each area in a step-by-step manner. In this case, the accident occurrence risk in each area preferably has five levels and more preferably ten levels. A larger index value means a higher accident occurrence risk.

When the tire information detection device 10 includes the accident occurrence risk calculation unit 17a, the determination unit 15 uses, as the determination condition, the index value of the accident occurrence risk in each area calculated by the accident occurrence risk calculation unit 17a, and the control unit 16 controls the measurement of the detection unit 11 based on the index value of the accident occurrence risk in an area including the current position. Specifically, the control unit 16 controls such that the measurement frequency of the detection unit 11 is increased in an area having a larger index value of the accident occurrence risk. For example, the detection unit 11 performs measurement once a week in an area having an accident occurrence risk of level 1 and performs measurement each time an area having an accident occurrence risk of level 10 is passed. To prevent the service life of the power supply unit 12 from degrading, however, the upper limit of the number of times of measurement (up to 3 times per day) is preferably set. Even in passing through an area that is not an accident-prone area, when similarity to another accident-prone area is recognized, it is preferable to control the detection unit 11 to perform measurement. In this case, for example, the four items of the visibility from the height and arrangement of surrounding buildings, the presence or absence of traffic signals, the presence or absence of road signs, and the traffic volume are normalized, the total value of each item having 25 points is calculated, and the detection unit 11 performs measurement when the similarity is 65 points or more compared with other accident-prone areas. In evaluating the similarity with other accident-prone areas, an item other than the above four items exemplified may be added as appropriate.

The measurement frequency calculation unit 17b calculates an index value of the measurement frequency of the detection unit 11 based on the environmental information included in the additional information acquired by the additional information acquisition unit 14. Examples of this environmental information include weather information (for example, rainfall information and snow information), areas where fallen leaves tend to accumulate, and sunshine hours. The measurement frequency calculation unit 17b calculates the measurement frequency of the detection unit 11 based on the environmental information to quantify the measurement frequency in a step-by-step manner. For example, when it rains or snows, the measurement frequency is increased based on rainfall information and snow information, and the measurement frequency is increased in autumn in areas where fallen leaves tend to accumulate. A larger index value of the measurement frequency of the detection unit 11 means a higher measurement frequency of the detection unit 11.

When the tire information detection device 10 includes the measurement frequency calculation unit 17b, the determination unit 15 uses, as the determination condition, the index value of the measurement frequency of the detection unit 11 calculated by the measurement frequency calculation unit 17b, and the control unit 16 controls the measurement of the detection unit 11 based on the index value of the measurement frequency of the detection unit 11 in an area including the current position. Specifically, the control unit 16 controls such that the measurement frequency of the detection unit 11 is increased in an area having a larger index value of the measurement frequency. For example, when the index value of the measurement frequency of the detection unit 11 is set to three levels, the detection unit 11 performs measurement once a week in an area having the index value of the measurement frequency of level 1 and performs measurement each time an area having the index value of level 3 is passed. It is also possible to control such that measurement is performed in the morning and evening but not during the day in consideration of the season and hours of sunshine.

The image comparison calculation unit 17c compares a prerecorded surrounding image of the vehicle included in the additional information with the image during travel and calculates the concordance rate of the images. Specifically, the image comparison calculation unit 17c calculates, with image processing, the concordance rate of an image during travel (for example, an image from cameras or drive recorders mounted on the vehicle) to a prerecorded image of the surroundings of the vehicle (for example, a satellite image of the surroundings of the vehicle).

When the tire information detection device 10 includes the image comparison calculation unit 17c, the determination unit 15 uses the concordance rate of the images as the determination condition, and the control unit 16 controls the measurement of the detection unit 11 based on the concordance rate of the images in an area including the current position. Specifically, the control unit 16 controls such that the detection unit 11 performs measurement when the concordance rate of the images is low (for example, when the concordance rate is 65% or less).

Various measurement values measured by the detection unit 11 are recorded in the recording unit 18. Here, the recording unit 18 can be composed of an external recording device, such as a hard disk, or an internal recording device, such as a RAM, or a combination thereof. The recording unit 18 can also include a measurement history recording unit 18a and a danger avoidance behavior recording unit 18b.

The measurement history recording unit 18a records the measurement history of the detection unit 11 at the current position specified based on the position information. That is, the position information and the measurement history of the detection unit 11 are associated and integrally recorded in the measurement history recording unit 18a.

When the tire information detection device 10 includes the measurement history recording unit 18a, the determination unit 15 uses the presence or absence of the measurement history of the detection unit 11 as the determination condition, and the control unit 16 controls the measurement of the detection unit 11 based on the presence or absence of the measurement history of the detection unit 11 in an area including the current position. Specifically, when the measurement history of the detection unit 11 is not recorded in the measurement history recording unit 18a, the control unit 16 controls the detection unit 11 to start measurement.

The danger avoidance behavior recording unit 18b records information about a danger avoidance behavior at the current position specified based on the position information. That is, the position information and the danger avoidance behavior are associated and integrally recorded in the danger avoidance behavior recording unit 18b. Examples of the information about this danger avoidance behavior include abrupt braking, abrupt steering, and a sudden change in vehicle speed. The danger index calculation unit 17d calculates an index value of danger in each area based on the information about the danger avoidance behavior recorded in the danger avoidance behavior recording unit 18b. Specifically, the ratio of the number of times of danger avoidance behavior in a specific area to the total number of times of danger avoidance behavior in any range (for example, city or prefecture) is calculated to quantify the danger in each area in a step-by-step manner. In this case, the danger in each area is preferably 5 levels and more preferably 10 levels. A larger index value means more frequent occurrences of danger avoidance behavior and a higher accident occurrence risk.

When the tire information detection device 10 includes the danger avoidance behavior recording unit 18b and the danger index calculation unit 17d, the determination unit 15 uses the index value of danger in each area as the determination condition, and the control unit 16 controls the measurement of the detection unit 11 based on the index value of the danger in an area including the current position. Specifically, the control unit 16 controls such that the measurement frequency of the detection unit 11 is increased in an area having a higher index value of danger. For example, the detection unit 11 performs measurement once a week in an area having the index value of danger of level 1 and performs measurement each time an area having the index value of danger of level 10 is passed. To prevent the service life of the power supply unit 12 from deteriorating, however, the upper limit of the number of times of measurement (up to 3 times per day) is preferably set. In this manner, the control unit 16 controls the detection unit 11 to start measurement when information about the danger avoidance behavior is recorded in the danger avoidance behavior recording unit 18b.

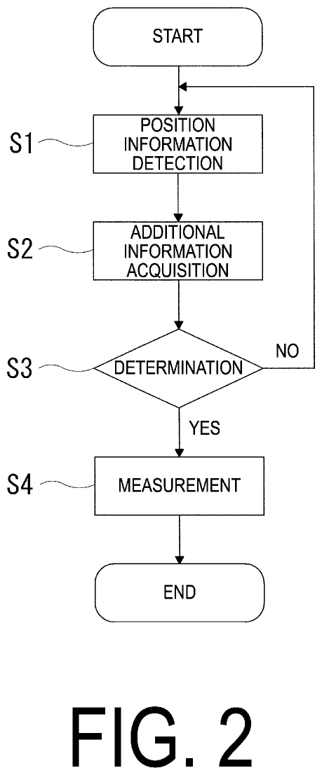

FIG. 2 illustrates a procedure of a detection method using a tire information detection device according to an embodiment of the present technology. In FIG. 2, it is assumed that the procedure starts from a state where the detection unit 11 mounted on the tire information detection device 10 performs no measurement.

In detecting tire information of the tire T, in step S1, the position information detection unit 13 of the tire information detection device 10 detects position information (latitude, longitude, and altitude) of the tire or the vehicle. Then, the position information detection unit 13 specifies the current position of the tire or the vehicle based on the detected position information.

Next, proceeding to step S2, the additional information acquisition unit 14 of the tire information detection device 10 acquires additional information associated with the position information of the tire or the vehicle. Then, the additional information acquisition unit 14 extracts specific information from the additional information associated with the position information according to the tire information as the detection target. This extracted additional information is used as the determination condition of the determination unit 15.

Next, proceeding to step S3, and the determination unit 15 of the tire information detection device 10 determines whether the current position of the tire or the vehicle is included in an area that satisfies the determination condition extracted from the additional information. For example, when the detection target is a road surface state, the determination unit 15 determines whether the current position is included in a specific area (such as accident-prone area, flooded area, and area where fallen leaves tend to accumulate). When the detection target is wear of a tire, the determination unit 15 determines whether the current position is included in a prerecorded area where a user is highly likely to travel on a steady state. When the detection target is deformation of the tire or a load state of the tire, the determination unit 15 determines whether the current position is included in an area that satisfies the determination condition corrected based on the road gradient and vehicle information. If the current position is included in the area that satisfies the determination condition, the flow proceeds to step S4. If the current position is not included in the area that satisfies the determination condition, the flow returns to step S1.

Next, proceeding to step S4, and the control unit 16 of the tire information detection device 10 controls the detection unit 11 to start measurement. Although the detection unit 11 starts measurement in this way, steps S1 to S3 are repeated while the vehicle is traveling, and the control unit 16 controls the detection unit 11 to end measurement when, in step S3, the current position is not included in the area that satisfies the determination condition. As the vehicle travels, the current position changes constantly, and the determination conditions extracted from the additional information associated with the position information also change accordingly. Thus, the measurement of the detection unit 11 is also repeatedly started and ended during traveling of the vehicle.

When the detection target is wear of a tire, the measurement frequency of the detection unit 11 is relatively low. When the detection target is a road surface state, the measurement frequency of the detection unit 11 is relatively high. When the detection target is deformation, a ground contact state, or a load state of the tire, the measurement frequency of the detection unit 11 is appropriately changed according to the request.

The tire information detection device described above includes at least one detection unit 11 disposed on the tire inner surface, the power supply unit 12 configured to supply power to the detection unit 11, the position information detection unit 13 configured to detect position information of the tire or the vehicle, the additional information acquisition unit 14 configured to acquire additional information associated with the position information, the determination unit 15 configured to determine whether the current position specified based on the position information is included in an area that satisfies the determination condition extracted from the additional information, and the control unit 16 configured to control the measurement of the detection unit 11 based on the determination result from the determination unit 15. Thus, the detection unit performs measurement using the position information of the tire or the vehicle when the current position specified based on the position information is included in an area that satisfies the determination condition extracted from the additional information. That is, the tire information detection device according to an embodiment of the present technology has a trigger function to encourage the detection unit 11 to measure. Thus, measurement can be performed in the right place at the right time instead of constant measurement, and the measurement frequency of the detection unit 11 can be reduced as much as possible to reduce power consumption. This can detect tire information in the right place at the right time while extending the service life of the power supply unit 12.

The tire information detection device preferably has the accident occurrence risk calculation unit 17a configured to calculate an index value of an accident occurrence risk based on the number of accident occurrences in each area included in the additional information. The determination unit 15 preferably uses the index value of the accident occurrence risk in each area as the determination condition. The control unit 16 preferably controls the measurement of the detection unit 11 based on the index value of the accident occurrence risk in an area including the current position. In this way, since the index value calculated by the accident occurrence risk calculation unit 17a is used as the determination condition, the service life of the power supply unit 12 can be extended and the accident occurrence risk can be reduced. Thus, the safety can be improved.

The tire information detection device preferably has the measurement frequency calculation unit 17b configured to calculate the index value of the measurement frequency of the detection unit 11 based on the environmental information included in the additional information. The determination unit 15 preferably uses the index value of the measurement frequency of the detection unit 11 as the determination condition. The control unit 16 preferably controls the measurement of the detection unit 11 based on the index value of the measurement frequency of the detection unit 11 in an area including the current position. Using, as the determination condition, the index value of the measurement frequency of the detection unit 11 calculated by the measurement frequency calculation unit 17b leads to reduction of the accident occurrence risk while extending the service life of the power supply unit 12, allowing the safety to be improved.

The tire information detection device preferably has the image comparison calculation unit 17c configured to compare a prerecorded surrounding image of the vehicle included in the additional information with an image during travel to calculate a concordance rate of the images. The determination unit 15 preferably uses the concordance rate of the images as the determination condition. The control unit 16 preferably controls the measurement of the detection unit 11 based on the concordance rate of the images in an area including the current position. Even if the current position is not included in the accident-prone area, when the concordance rate of the images does not satisfy a predetermined value, by controlling the detection unit 11 to perform measurement, the accident occurrence risk can be reduced, and the safety can be improved.

The tire information detection device preferably has the measurement history recording unit 18a configured to record the measurement history of the detection unit 11 at the current position specified based on the position information. The determination unit 15 uses the presence or absence of the measurement history of the detection unit 11 as the determination condition. The control unit 16 preferably controls the measurement of the detection unit 11 based on the presence or absence of the measurement history of the detection unit 11 in an area including the current position. For example, when a vehicle travels through an intersection that it enters for the first time, even if the intersection does not correspond to an accident-prone area, controlling the detection unit 11 to perform measurement leads to reduction of the accident occurrence risk. allowing the safety to be improved.

The tire information detection device preferably has the danger avoidance behavior recording unit 18b configured to record information about danger avoidance behavior at the current position specified based on the position information, and the danger index calculation unit 17d configured to calculate an index value of danger in each area based on the information about the danger avoidance behavior. The determination unit 15 preferably uses the index value of the danger in each area as the determination condition. The control unit 16 preferably controls the measurement of the detection unit 11 based on the index value of the danger in an area including the current position. Even if the current position is not included in the accident-prone area, when the information about the danger avoidance behavior is recorded in the danger avoidance behavior recording unit 18b, controlling the detection unit 11 to perform measurement leads to reduction of the accident occurrence risk, allowing the safety to be improved.

In the tire information detection device, preferably, the tire information includes wear of a tire, the determination unit 15 uses information related to wear of a tire included in the additional information as the determination condition, and the measurement of the detection unit 11 is repeated until the tire rotation speed reaches 10 rotations or more. The progress of wear of the tire can be determined even if measurement is performed for one rotation of the tire. However, from the viewpoint of improving the determination accuracy, the tire rotation speed is preferably 30 rotations or more, more preferably 50 rotations or more, most preferably 100 rotations or more. In this case, the measurement of the detection unit 11 may be performed continuously or may be performed intermittently over a plurality of days. In addition, when the determination unit 15 makes determination based on the determination conditions, a machine learning model may be used, and the determination accuracy can be improved in this case as well. As machine learning models, known machine learning models such as decision trees, random forests, logistic regression, support vector machines (SVM), naive Bayes classifiers, k-nearest neighbors, Adaboost, and neural networks can be used. When wear of a tire is detected by thus performing measurement of the detection unit 11 until a predetermined tire rotation speed is reached, the service life of the power supply unit 12 can be extended, and the determination accuracy of the progress of wear of a tire can be improved.

It is preferable that the measurement by the detection unit 11 is basically performed under the same road surface state and speed condition until the tire rotation speed reaches a predetermined tire rotation speed. However, if the tire rotation speed has not reached the predetermined tire rotation speed after one month from the first measurement, the measurement result at that time is handled as a provisional measurement result. If the tire rotation speed has not reached the predetermined tire rotation speed, a more suitable area may be set based on the road surface state and speed conditions similar to those at the time of the previous measurement and the current travel history.

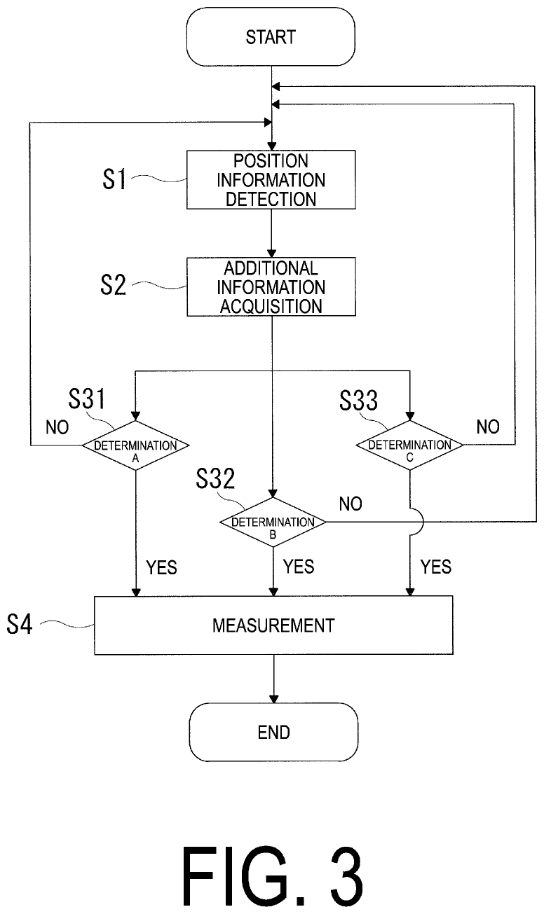

FIG. 3 illustrates a modified example of a procedure of a detection method using a tire information detection device according to an embodiment of the present technology. FIG. 2 illustrates a single example of the determination condition of the determination unit 15, but FIG. 3 illustrates an example of adopting a plurality of determination conditions. In FIG. 3, the procedure from step S1 to step S2 is the same as in FIG. 2. In FIG. 3, it is assumed that the procedure starts from a state where the detection unit 11 mounted on the tire information detection device 10 performs no measurement.

In steps S31 to S33 subsequent to step S2, determinations A to C are performed by the determination unit 15, respectively. The determination unit 15 has a plurality of determination conditions a to c. For example, the index value of the accident occurrence risk in each area is set as the determination condition a, the index value of the measurement frequency of the detection unit 11 is set as the determination condition b, and the presence or absence of the measurement history of the detection unit 11 is set as the determination condition c. In this case, the determination unit 15 determines whether the current position is included in an area that satisfies the determination conditions a to c. If the current position is included in an area that satisfies any of the determination conditions a to c, the flow proceeds to step S4. If the current position is not included in the area that satisfies the determination conditions, the flow returns to step S1. In step S4, the control unit 16 of the tire information detection device 10 controls the detection unit 11 to start measurement. Note that while the current position is included in an area that satisfies any one of the determination conditions a to c, the measurement of the detection unit 11 is continued. While the current position is no longer included in the area that satisfies any one of the determination conditions a to c, the measurement of the detection unit 11 ends.

As described above, the determination unit 15 has at least two determination conditions and selectively uses at least two determination conditions according to the tire information as the detection target. Thus, the service life of the power supply unit 12 can be extended and the tire information can be detected in the right place at the right time.

FIG. 4 illustrates a pneumatic tire (tire T) for which the tire information is detected by the tire information detection device 10 according to an embodiment of the present technology.

As illustrated in FIG. 4, the tire T includes the tread portion 1 extending in the tire circumferential direction and having an annular shape, a pair of sidewall portions 2, 2 disposed on both sides of the tread portion 1, and a pair of bead portions 3, 3 disposed on inner sides of the sidewall portions 2 in a tire radial direction.

A carcass layer 4 is mounted between the pair of bead portions 3, 3. The carcass layer 4 includes a plurality of reinforcing cords extending in the tire radial direction and is folded back around a bead core 5 disposed in each of the bead portions 3 from a tire inner side to a tire outer side. A bead filler 6 having a triangular cross-sectional shape and formed of a rubber composition is disposed on the outer circumference of the bead core 5. Furthermore, an innerliner layer 9 is disposed in an area between the pair of bead portions 3, 3 on a tire inner surface Ts. The innerliner layer 9 forms the tire inner surface Ts.

On the other hand, a plurality of belt layers 7 are embedded on the outer circumferential side of the carcass layer 4 in the tread portion 1. The belt layers 7 include a plurality of reinforcing cords that are inclined with respect to the tire circumferential direction, and the reinforcing cords are disposed so as to intersect each other between the layers. In the belt layers 7, the inclination angle of the reinforcing cords with respect to the tire circumferential direction is set to fall within a range of from 10° to 40°, for example. Steel cords are preferably used as the reinforcing cords of the belt layers 7. To improve high-speed durability, at least one belt cover layer 8 formed by arranging reinforcing cords at an angle of, for example, 5° or less with respect to the tire circumferential direction is disposed on an outer circumferential side of the belt layers 7. Organic fiber cords such as nylon and aramid are preferably used as the reinforcing cords of the belt cover layer 8.

Note that the tire internal structure described above represents a typical example for a pneumatic tire, but the pneumatic tire is not limited thereto.

In the pneumatic tire described above, the tire information detection device 10 is attached to the tire inner surface Ts. This tire information detection device 10 constitutes one sensor module. In the tire information detection device 10, component parts consisting of the detection unit 11, the power supply unit 12, the position information detection unit 13, the additional information acquisition unit 14, the determination unit 15, the control unit 16, and the like are mounted inside a housing having a hollow structure. The tire information detection device 10 is fixed to the tire inner surface Ts via the housing.

1-8. (canceled)

9. A tire information detection device configured to detect tire information including at least one of wear of a tire, deformation of the tire, a road surface state, a ground contact state of the tire, presence or absence of failure of the tire, a travel history of the tire, a load state of the tire, or a frictional coefficient, the tire information detection device comprising:
at least one detection unit disposed on a tire inner surface;
a power supply unit configured to supply power to the detection unit;
a position information detection unit configured to detect position information of the tire or a vehicle;
an additional information acquisition unit configured to acquire additional information associated with the position information;
a determination unit configured to determine whether a current position specified based on the position information is included in an area that satisfies a determination condition extracted from the additional information; and
a control unit configured to control measurement of the detection unit based on a determination result from the determination unit.

10. The tire information detection device according to claim 9, wherein the determination unit has at least two determination conditions and selectively uses the at least two determination conditions according to tire information as the detection target.

11. The tire information detection device according to claim 9, further comprising
an accident occurrence risk calculation unit configured to calculate an index value of an accident occurrence risk in each area based on the number of accident occurrences included in the additional information, wherein
the determination unit uses the index value of the accident occurrence risk in each area as the determination condition, and
the control unit controls the measurement of the detection unit based on the index value of the accident occurrence risk in an area including the current position.

12. The tire information detection device according to claim 9, wherein
the tire information includes wear of the tire,
the determination unit uses information related to the wear of the tire included in the additional information as the determination condition, and
the measurement made by the detection unit is repeated until a tire rotation speed reaches 10 rotations or more.

13. The tire information detection device according to claim 9, further comprising
a measurement frequency calculation unit configured to calculate an index value of a measurement frequency of the detection unit based on environmental information included in the additional information, wherein
the determination unit uses the index value of the measurement frequency of the detection unit as the determination condition, and
the control unit controls the measurement of the detection unit based on the index value of the measurement frequency of the detection unit in an area including the current position.

14. The tire information detection device according to claim 9, further comprising
an image comparison calculation unit configured to compare a prerecorded surrounding image of the vehicle included in the additional information with an image during travel to calculate a concordance rate of images, wherein
the determination unit uses the concordance rate of the images as the determination condition, and
the control unit controls the measurement of the detection unit based on the concordance rate of the images in an area including the current position.

15. The tire information detection device according to claim 9, further comprising
a measurement history recording unit configured to record a measurement history of the detection unit at the current position specified based on the position information, wherein
the determination unit uses presence or absence of the measurement history of the detection unit as the determination condition, and
the control unit controls the measurement of the detection unit based on the presence or absence of the measurement history of the detection unit in an area including the current position.

16. The tire information detection device according to claim 9, further comprising:
a danger avoidance behavior recording unit configured to record information about danger avoidance behavior at the current position specified based on the position information; and
a danger index calculation unit configured to calculate an index value of danger in each area based on the information about the danger avoidance behavior, wherein
the determination unit uses the index value of the danger in each area as the determination condition, and
the control unit controls the measurement of the detection unit based on the index value of the danger in an area including the current position.

17. The tire information detection device according to claim 10, wherein
the tire information includes wear of the tire,
the determination unit uses information related to the wear of the tire included in the additional information as the determination condition, and
the measurement made by the detection unit is repeated until a tire rotation speed reaches 10 rotations or more.

18. The tire information detection device according to claim 17, further comprising
a measurement frequency calculation unit configured to calculate an index value of a measurement frequency of the detection unit based on environmental information included in the additional information, wherein
the determination unit uses the index value of the measurement frequency of the detection unit as the determination condition, and
the control unit controls the measurement of the detection unit based on the index value of the measurement frequency of the detection unit in an area including the current position.

19. The tire information detection device according to claim 18, further comprising
an image comparison calculation unit configured to compare a prerecorded surrounding image of the vehicle included in the additional information with an image during travel to calculate a concordance rate of images, wherein
the determination unit uses the concordance rate of the images as the determination condition, and
the control unit controls the measurement of the detection unit based on the concordance rate of the images in an area including the current position.

20. The tire information detection device according to claim 19, further comprising
a measurement history recording unit configured to record a measurement history of the detection unit at the current position specified based on the position information, wherein
the determination unit uses presence or absence of the measurement history of the detection unit as the determination condition, and
the control unit controls the measurement of the detection unit based on the presence or absence of the measurement history of the detection unit in an area including the current position.

21. The tire information detection device according to claim 20, further comprising:
a danger avoidance behavior recording unit configured to record information about danger avoidance behavior at the current position specified based on the position information; and
a danger index calculation unit configured to calculate an index value of danger in each area based on the information about the danger avoidance behavior, wherein
the determination unit uses the index value of the danger in each area as the determination condition, and
the control unit controls the measurement of the detection unit based on the index value of the danger in an area including the current position.
